(19) United States
(12) Patent Application Publication
(10) Pub. No.: US 2010/0139163 A1
(43) Pub. Date: Jun. 10, 2010

(54) Water self-sufficient garden pot

(76) Inventor: John Hassan Borazjoni, Agoura Hills, CA (US)

Correspondence Address: JOHN H. BORAZJONI, 29311 Oak Path Dr., Agoura Hills, CA, 91301, US

(21) Appl. No.: 12/316,071

(22) Filed: Dec. 9, 2008

(51) Int. Cl. A01G 27/02

(52) U.S. Cl. 47/79

(57) ABSTRACT

Means introduced for variety of Garden Pots to be Water Self-sufficient for usage privately and as well as in commercial purposes. The invention comprising of an improved garden pot made out of two layers, the inner layer and outer layer, which are about an inch or so apart, hence creating an empty space between them. It is in the space between the two layers would work as reservoir that water would be purred in, and contained. The outer layer is solid, but the inner layer has several needle's tip size holes, through which water would penetrate into the inner layer space that is full of soil, and would keep the soil moist and watered at all times, thereby continuously watering the plant growing in the soil, drop by drop. As an advantage, once the user would fill up the pot's reservoir with water, the plant would be automatically watered for weeks to come, without further and frequent care and check ups. Hence constant bothersome of watering the plants grown in the garden pots by an individual user are hereby illuminated.

Applicant, John H. Borazjoni claims priority under 35 USC § 119 (e), based upon his prior Provisional Application No. 60/411,712 filed on Sep. 19, 2002, which is incorporated herein by reference.

### A. BACKGROUND OF THE INVENTION

1. Field of the Invention

This invention relates to garden equipment and accessories, and more specifically it relates to an improved garden “POT” that is Water Self-Sufficient, in order to support the growth the plant in it. This improved garden pot comes in variety of shapes and sizes, however the concept of being water self-sufficient would remain the same.

Measurement: The invention is suggested for garden pot made by plastic, but metal, clay and other materials may be used, in variety of sizes and shapes.

The material and strength of the garden pot is depending upon its size, shape and the soil & plant which expected to be grown into it.

2. Description of Prior Art

Throughout the history, conventional garden pots have been the most valuable means to grow plants for pleasure private use and as well as commercial use. Conventional garden pots have been made from many different materials, such as clay, glass, metal, aluminum, gold, silver, plastic, even paper and etc.

However, in order for the plant to grow in the pot, one of the most essential needs is water. Therefore, the plant needs to be watered properly and sufficiently, which requires frequent care and check ups, and that is the most shortcoming of the prior art, the conventional garden pot, which un-watered plants would be lost soon thereafter.

There have been several means for watering the plant in the garden pot introduced in the prior arts, and their improved thereof.

However, those arts maybe suitable for the particular purposes in which they were targeting and addressed, but they would not be as practical and simple to use for watering the plant in the garden pots by an individual as the present invention as herein described.

### B. SUMMARY AND OBJECTIVES OF THE INVENTION

The present invention discloses an apparatus for improving the usage and operations of garden pots. The primary objective of the present invention is to provide improved means for garden pot that would be supporting the growth of the plant in it, and to overcome the shortcoming and bothersome of the prior arts, by its practicalities and simplicities, and general care fee use.

More particularly, it is objective of the present invention to enjoy having a nice and healthy plant grown in a garden pot, which needs no frequent care and check ups for long period of times, and weeks to come, only by one simple watering.

In keeping with these objectives and other which will become apparent herein, and to accomplish the comfort of individual user, whether for private or commercial use, the present invention has created a garden pot made out of two layers, the inner layer and outer layer. The layers are apart about an inch or so by a hollow space, which hollow space would be used a reservoir for water to be purred into it and thereby contained, whereby said piece of material of a single unit.

The outer layer is solid, however the inner layer has several needle's tip size holes, as means for the water that has been contained in the space between the layers to penetrate into the inside space of the inner layer, which is full of soil, and thereby would moist and water the soil and the plant that is growing in the soil, continuously drop by drop for weeks to come, without users frequent care and check ups. Thereby, individual user is relaxed and use its time for other purposes, care free of the plant growing in the garden pot.

Another objective is to provide efficient garden pot, which would support all kinds of plants, such as heavy water consumption plants, with more holes in the inner layer, and a normal water consumption plants would have normal count holes. In general to have a garden pot that is in all respect looks, shapes, sizes and operates like any other conventional garden pots already in use by the public, hence users do not need any special training or learning course as to how to use it. The plastic garden pot of this invention and/or other kind is recyclable in the same manner as the other conventional plastic or else garden pots already in the public use.

Yet another objective is that by utilizing present design, the user would technically continue watering the plant grown in the garden pot, while is not physically available, such as but not limited to when on trip for weeks or etc., which by the introduced means the plant continue receiving water as needed, and in the amount needed.

Yet furthermore objective of the present invention is to prevent over/under watering of the plant by inexperience users, since the amount of the watering is set, which would grow the plant faster, better and healthier. There would be a see through part for user to monitor the amount of water left in the reservoir of the garden pot to be filled as needed periodically.

Further important objective of the present invention is to conserve and save valuable water from being wasted, especially in areas of warm and/or hot weather condition, which water availabilities are short, and therefore also expensive. As such present invention would both save water consumption and money as well.

A still further objective is to provide an easy garden pot that is practical both operationally and financially, which upon completion of mess production, it would be priced to public at basically the same range as existing conventional garden pots of kind, as such it would be yet most economical and profitable to both individual users, and as well as the manufactures.

The above accomplishment and related object of the present invention may be embodied in the form of illustrated in the enclosed drawing. However, it should be clearly understood that these raw drawings are illustrative only and changes may be made in the specific construction illustrated and described within the appended claims.

### C. BRIEF DESCRIPTION OF THE DRAWING

In an effort, that the invention would be better understood, the followings are described, with the reference to the accompanying drawings;

FIG. “1” is a diagrammatic side view “cut-a-way” of the invention, displaying its feature of the Water Self-Sufficient Garden Pot. The purpose of this view is to show, how and where the water is contained. However, the size and shape would come in variety of different of what has been showed, yet the concept of watering self-sufficient would be the same in all kind to be made.

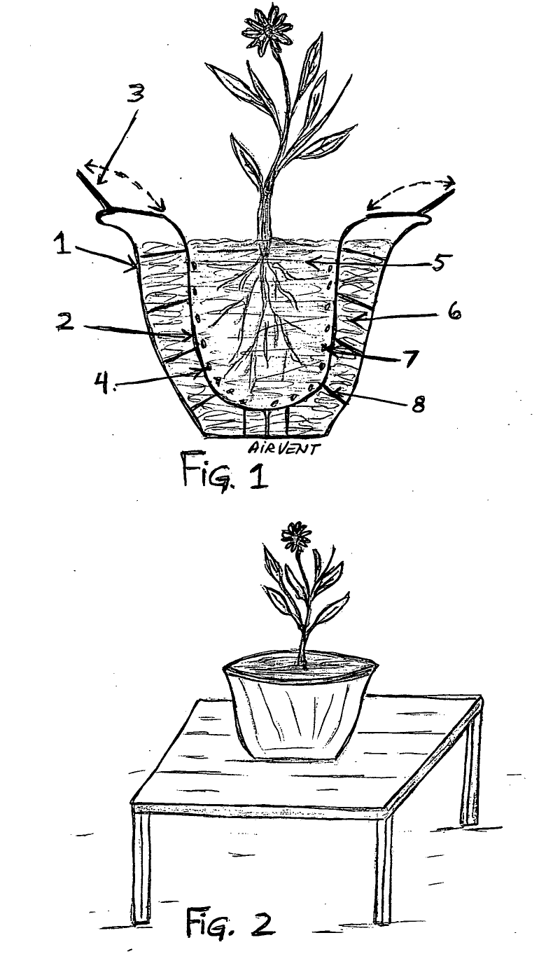

Now turning descriptively to the drawing of FIG. 1, in which numerical references are as follows;
1. Inner layer
2. Outer layer
3. Led (to pure water in the reservoir)
4. Holes (needle's tip size)
5. Soil
6. Water
7. Simulated water drops
8. Connecting small post between layers

FIG. “2” is an example of perspective view of the instant invention on the desk top, yet not limited to it, and invention may be used in different size and shape for whatever purpose.

It will be clearly understood that each of the elements described, or two or more together may also find a useful application in other types of methods differing from the type described.

While certain novel feature of this invention have been shown and described and/or pointed out in annexed claims, it is not intended to be limited to the detail described, since it would be understood that various omissions, modifications, substitutions and changes in the forms and details of the device illustrated and in its operations could be made by those skilled in the art, without departing in anyway from the spirit of present invention.

The foregoing will clearly reveal the gist of the present invention, and without further analysis others could apply the current knowledge and readily adapt them for various applications without omitting features that, from the standpoint of prior art, fairly constitute essential characteristics of the generic or specific aspect of this invention.

The present invention has claims that are new, and it is desired to protect them by the Letter Patent is set forth in the appended claims:

1. Garden pot made out of two layers, the inner layer and outer layer that are apart by hollow space, whereby form piece of material of a single unit, as shown in FIGS. 1 and 2.

2. Garden pot made out of two layers, the inner layer and outer layer that are apart by hollow space, which the outer layer is solid and inner layer has several needle's tip size holes, whereby form piece of material of single unit, as shown in FIGS. 1 and 2.

3. Garden pot made out of two layers, the inner layer and outer layer that are apart by hollow space used as reservoir, in which space water would be purred in from the led on top of pot, and contained in the said reservoir, whereby form piece of material of single unit, as shown in FIGS. 1 and 2.

4. In the claim 2, the inner layer has several needle's tip size holes as means for water to penetrate through into the soil kept inside space of the inner layer, in order to water the plant growing in the soil, drop by drop, as shown in FIG. 1.

5. In the claim 3, the water kept in the reservoir created by hollow space between the inner and outer layers, is as means for providing a garden pot that is water self-sufficient, to support the growth the plant in the garden pot, as shown in FIG. 1.

6. In the claim 2, the count of needle's tip holes made in the inner layer are depend upon the size of the pot and the water consumption of the plant that would be grown in the pot, and are generally divided into heavy water consumption plant that would most holes and normal water consumption plant, with less or normal holes.
